(19) United States
(12) Patent Application Publication
(10) Pub. No.: US 2026/0056224 A1
(43) Pub. Date: Feb. 26, 2026

(54) Sensor Module

(71) Applicant: SEIKO EPSON CORPORATION, Tokyo (JP)

(72) Inventor: Fumiya ITO, Suwa (JP)

(21) Appl. No.: 19/308,800

(22) Filed: Aug. 25, 2025

(30) Foreign Application Priority Data
Aug. 26, 2024 (JP) 2024-144423

(51) Int. Cl. G01P 3/02

(52) U.S. Cl. CPC G01P 3/02

(57) ABSTRACT

A sensor module includes a plurality of sensor devices that have detection axes along a same direction and detect a same type of physical quantity, a storage unit that stores parameter information including parameters as indexes representing output stability of the respective plurality of sensor devices, a plurality of integration processing units that perform integration processing based on output signals of the respective plurality of sensor devices, and an arithmetic processing section that performs arithmetic processing according to the parameter information and integration times of the integration processing on the output signals of the plurality of integration processing units.

The present application is based on, and claims priority from JP Application Serial Number 2024-144423, filed Aug. 26, 2024, the disclosure of which is hereby incorporated by reference herein in its entirety.

### BACKGROUND

### 1. Technical Field

The present disclosure relates to a sensor module.

### 2. Related Art

JP-A-2000-283788 describes an inertial navigation apparatus that calculates an optimum weight according to a degree of normality or a degree of quality of a function of each inertial navigation apparatus in multiplexed inertial navigation apparatuses, and outputs optimum navigation information (attitude angle, azimuth angle, velocity, and position) according to output of each inertial navigation apparatus and the weight. According to the inertial navigation apparatus described in JP-A-2000-283788, safe and highly reliable navigation can be implemented by providing highly accurate navigation information.

JP-A-2000-283788 is an example of the related art.

However, in the inertial navigation apparatus described in JP-A-2000-283788, since the output stability of an inertial sensor changes with the passage of time according to the Allan variance, the accuracy of the navigation information to be output may be significantly reduced.

### SUMMARY

A sensor module according to an aspect of the present disclosure includes a plurality of sensor devices that have detection axes along a same direction and detect a same type of physical quantity, a storage unit that stores parameter information including parameters as indexes representing output stability of the respective plurality of sensor devices, a plurality of integration processing units that perform integration processing based on output signals of the respective plurality of sensor devices, and an arithmetic processing section that performs arithmetic processing according to the parameter information and integration times of the integration processing on the output signals of the plurality of integration processing units.

### BRIEF DESCRIPTION OF THE DRAWINGS

FIG. 1 shows a functional configuration of a sensor module according to an embodiment.

FIG. 2 shows simulation results of Allan variance.

FIG. 3 shows simulation results of variance of an integration error.

FIG. 4 shows an X-axis, a Y-axis, and a Z-axis.

FIG. 5 shows a configuration example of a sensor module according to a first embodiment.

FIG. 6 shows a configuration example of an arithmetic processing section in the first embodiment.

FIG. 7 shows a configuration example of a sensor module according to a second embodiment.

FIG. 8 shows a configuration example of an arithmetic processing section in a third embodiment.

FIG. 9 shows an example of a combined navigation system incorporating the sensor module of the embodiment.

### DESCRIPTION OF EMBODIMENTS

Hereinafter, preferred embodiments of the present disclosure will be described in detail with reference to the drawings. Note that the embodiments to be described below do not unduly limit the present disclosure described in What is claimed is. Further, not all configurations to be described below are necessarily essential elements of the present disclosure.

### 1. First Embodiment

### 1-1. Functional Configuration of Sensor Module

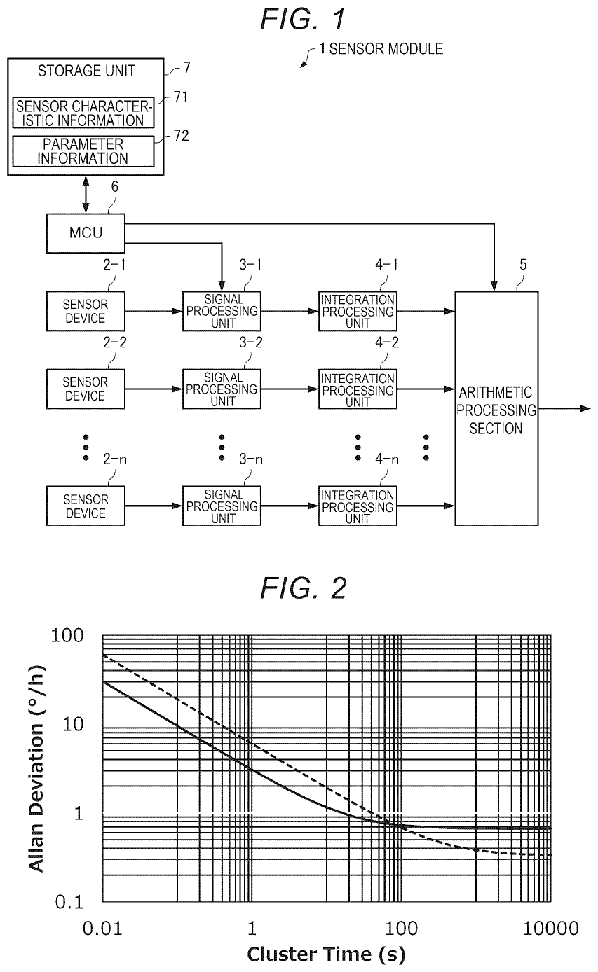

FIG. 1 shows a functional configuration example of a sensor module according to the embodiment. As shown in FIG. 1, a sensor module 1 of the present embodiment includes n sensor devices 2-1 to 2-n, n signal processing units 3-1 to 3-n, n integration processing units 4-1 to 4-n, an arithmetic processing section 5, a micro control unit 6, and a storage unit 7. The n is an integer of 2 or more. That is, the sensor module 1 includes a plurality of sensor devices 2-1 to 2-n, a plurality of signal processing units 3-1 to 3-n, and a plurality of integration processing units 4-1 to 4-n. The sensor module 1 may have a configuration in which part of the elements in FIG. 1 are omitted or changed, or other elements are added. For example, when a signal processing unit is provided in each of the sensor devices 2-1 to 2-n, the sensor module 1 may not include the signal processing units 3-1 to 3-n.

The sensor devices 2-1 to 2-n have detection axes along the same direction and detect the same type of physical quantity. The physical quantity may be, for example, an angular velocity or an acceleration. Each of the sensor devices 2-1 to 2-n may output a digital signal having a value corresponding to the detected physical quantity, or may output an analog signal having a voltage corresponding to the detected physical quantity. Each of the sensor devices 2-1 to 2-n may be an inertial sensor, and the sensor module 1 may be an inertial sensor module.

The storage unit 7 stores sensor characteristic information 71 and parameter information 72. The sensor characteristic information 71 is information such as bias, sensitivity, misalignment, and temperature characteristics of each of the sensor devices 2-1 to 2-n. The parameter information 72 includes a parameter of an index representing output stability of each of the sensor devices 2-1 to 2-n at rest.

Allan variance is known as an index representing the stability of output of a sensor at rest. The dominant characteristics of the Allan variance change with time. For example, the respective characteristics of the Allan variance of an angular velocity sensor include ARW (Angle Random Walk), BI (Bias Instability), RRW (Rate Random Walk), and RR (Rate Ramp), and the Allan variance σ² of the angular velocity sensor is expressed by Expression (1). In Expression (1), σ_{arw}², σ_{bi}², σ_{rrw}², and σᵣᵣ² are the Allan variances of the ARW, BI, RRW, and RR components, respectively. Further, T is an average time, and N, B, K, and R are parameters indicating characteristics of ARW, BI, RRW, and RR, respectively. The parameter information 72 includes, for example, values of parameters N, B, K, and R.

$${σ}^{2} = {σ}_{arw}^{2} + {σ}_{bi}^{2} + {σ}_{rrw}^{2} + {σ}_{rr}^{2} = \frac{{N}^{2}}{τ} + {( 0.664 B )}^{2} + \frac{{K}^{2} τ}{3} + \frac{{R}^{2} {τ}^{2}}{2} \qquad ( 1 )$$

The Allan variance of an acceleration sensor is expressed by Expression (2) in which the variance σ_{arw}² of ARW in Expression (1) is replaced with the variance σ_{vrw}² of VRW (Velocity Random Walk).

$${σ}^{2} = {σ}_{vrw}^{2} + {σ}_{bi}^{2} + {σ}_{rrw}^{2} + {σ}_{rr}^{2} = \frac{{N}^{2}}{τ} + {( 0.664 B )}^{2} + \frac{{K}^{2} τ}{3} + \frac{{R}^{2} {τ}^{2}}{2} \qquad ( 2 )$$

The micro control unit 6 reads the sensor characteristic information 71 stored in the storage unit 7 and outputs the sensor characteristic information 71 to each of the signal processing units 3-1 to 3-n. The micro control unit 6 reads the parameter information 72 stored in the storage unit 7 and outputs the parameter information 72 to the arithmetic processing section 5.

Each of the signal processing units 3-1 to 3-n performs predetermined signal processing on the output signal of each of the sensor devices 2-1 to 2-n. That is, a signal processing unit 3-i performs predetermined signal processing on the output signal of a sensor device 2-i for each integer i from 1 to n. The predetermined signal processing is, for example, filter processing or correction processing. The filter processing is, for example, low-pass filter processing, high-pass filter processing, or band-pass filter processing, and may be processing of a combination of two or more pieces of the filter processing. The correction processing is, for example, bias correction, sensitivity correction, alignment correction, temperature correction, or the like. The signal processing unit 3-i performs correction processing on the output signal of the sensor device 2-i based on the sensor characteristic information 71. When the sensor device 2-i outputs an analog signal, the signal processing unit 3-i may perform predetermined processing including processing of converting the analog signal into a digital signal.

Each of the integration processing units 4-1 to 4-n performs integration processing based on the output signal of each of the sensor devices 2-1 to 2-n. Specifically, each of the integration processing units 4-1 to 4-n performs integration processing on the output signal of each of the signal processing units 3-1 to 3-n. That is, an integration processing unit 4-i performs integration processing on the output signal of the signal processing unit 3-i. The integration processing of each of the integration processing units 4-1 to 4-n is reset by the micro control unit 6. Therefore, each of the integration processing units 4-1 to 4-n performs the integration processing from the release of the reset of the integration processing to the next reset. That is, the elapsed time from the release of the reset of the integration processing corresponds to an integration time.

The arithmetic processing section 5 performs arithmetic processing on the output signals of the integration processing units 4-1 to 4-n.

Each of the sensor devices 2-1 to 2-n is an angular velocity sensor, and each of the output signals of the integration processing units 4-1 to 4-n may be a signal corresponding to the attitude or the azimuth of the sensor module 1. Each of the sensor devices 2-1 to 2-n is an acceleration sensor, and each of the output signals of the integration processing units 4-1 to 4-n may be a signal corresponding to the velocity or the position of the sensor module 1.

Here, when each of the sensor devices 2-1 to 2-n is an angular velocity sensor, the variance σ_{ang}²(t) of the angle obtained by integrating the angular velocity is expressed by Expression (3) from Expression (1). In Expression (3), t is the integration time. Further, a₁, a₂, a₃, and a₄ are coefficients of the respective terms and are fixed values calculated in advance. Further, f_{arw}(t) is a function of an integration error by ARW, f_{bi}(t) is a function of an integration error by BI, f_{rrw}(t) is a function of an integration error by RRW, and fᵣᵣ(t) is a function of an integration error by RR. Therefore, the angle variance σ_{ang}²(t) corresponds to the variance of the integration error of the angular velocity. For example, the parameters N, B, K, and R are calculated based on the relationship between the variance σ_{ang}²(t) and the integration errors by the integration time t and ARW, BI, RRW, and RR obtained based on statistical analysis such as multiple regression analysis or theoretical analysis.

$$\begin{matrix}{σ}_{ang}^{2} ( t ) = {f}_{arw} ( t ) + {f}_{bi} ( t ) + {f}_{rrw} ( t ) + {f}_{rr} ( t ) \\ = {a}_{1} {N}^{2} t + {a}_{2} {B}^{2} {t}^{2} + {a}_{3} {K}^{2} {t}^{3} + {a}_{4} {R}^{2} {t}^{4}\end{matrix} \qquad ( 3 )$$

When each of the sensor devices 2-1 to 2-n is an acceleration sensor, the variance σᵥₑₗ²(t) of the velocity obtained by integrating the acceleration is expressed by Expression (4) from Expression (2). In Expression (4), t is the integration time. Further, b₁, b₂, b₃, and b₄ are coefficients of the respective terms, and are fixed values calculated in advance. Furthermore, g_{vrw}(t) is a function of an integration error by VRW, g_{bi}(t) is a function of an integration error by BI, g_{rrw}(t) is a function of an integration error by RRW, and gᵣᵣ(t) is a function of an integration error by RR. Therefore, the velocity variance σᵥₑₗ²(t) corresponds to the variance of the integration error of the acceleration. The parameters N, B, K, and R in Expression (4) are different from the parameters N, B, K, and R in Expression (3). For example, the parameters N, B, K, and R are calculated based on the relationship between the variance σᵥₑₗ²(t) and the integration error by the integration time t and VRW, BI, RRW, and RR obtained based on statistical analysis such as multiple regression analysis or theoretical analysis.

$$\begin{matrix}{σ}_{vel}^{2} ( t ) = {g}_{vrw} ( t ) + {g}_{bi} ( t ) + {g}_{rrw} ( t ) + {g}_{rr} ( t ) \\ = {b}_{1} {N}^{2} t + {b}_{2} {B}^{2} {t}^{2} + {b}_{3} {K}^{2} {t}^{3} + {b}_{4} {R}^{2} {t}^{4}\end{matrix} \qquad ( 4 )$$

When each of the sensor devices 2-1 to 2-n is an acceleration sensor, the variance σₚₒₛ²(t) of the position obtained by integrating the acceleration twice is expressed by Expression (5) from Expression (2). In Expression (5), t is the integration time. Further, c₁, c₂, c₃, and c₄ are coefficients of the respective terms, and are fixed values calculated in advance. Furthermore, h_{vrw}(t) is a function of an integration error by VRW, h_{bi}(t) is a function of an integration error by BI, h_{rrw}(t) is a function of an integration error by RRW, and hᵣᵣ(t) is a function of an integration error by RR. Therefore, the variance σₚₒₛ²(t) of the position corresponds to the variance of the integration error of the double integration of the acceleration. The parameters N, B, K, and R in Expression (5) are the same as the parameters N, B, K, and R in Expression (4).

$$\begin{matrix}{σ}_{pos}^{2} ( t ) = {h}_{vrw} ( t ) + {h}_{bi} ( t ) + {h}_{rrw} ( t ) + {h}_{rr} ( t ) \\ = {c}_{1} {N}^{2} {t}^{3} + {c}_{2} {B}^{2} {t}^{4} + {c}_{3} {K}^{2} {t}^{5} + {c}_{4} {R}^{2} {t}^{6}\end{matrix} \qquad ( 5 )$$

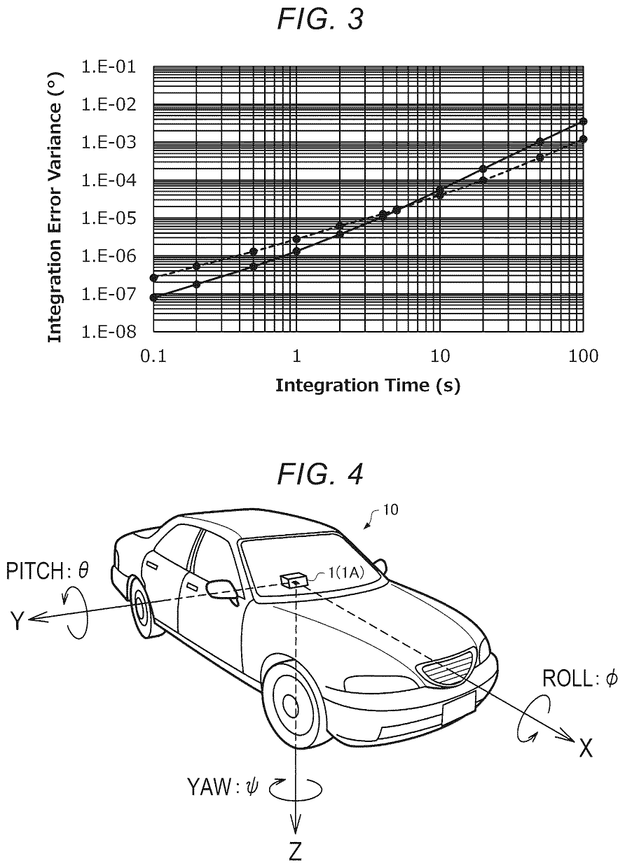

Since the values of the parameters N, B, K, and R are different for each of the sensor devices 2-1 to 2-n, the Allan variance and the variance of the integration error are also different for each of the sensor devices 2-1 to 2-n. For example, for two different angular velocity sensors, FIG. 2 shows simulation results of Allan variance, and FIG. 3 shows simulation results of variance of the integration error. In FIG. 2, the horizontal axis represents the average time T, and the vertical axis represents the Allan variance. In FIG. 3, the horizontal axis represents the integration time t, and the vertical axis represents the variance of the integration error. In FIGS. 2 and 3, solid lines indicate the simulation results of one angular velocity sensor, and broken lines indicate the simulation results of the other angular velocity sensor. As shown in FIG. 2, the magnitude relationship between the two Allan variances is switched before and after the average time T 80 seconds, and as a result, as shown in FIG. 3, the magnitude relationship between the variances of the two integration errors is switched before and after the integration time t≅5 seconds.

As described above, the variances of the integration errors of the integration processing units 4-1 to 4-n change according to the values of the parameters N, B, K, and R of the respective sensor devices 2-1 to 2-n and the integration times t of the integration processing of the integration processing units 4-1 to 4-n. Therefore, in the present embodiment, the arithmetic processing section 5 performs arithmetic processing on the output signals of the integration processing units 4-1 to 4-n according to the parameter information 72 and the integration times t of the integration processing of the integration processing units 4-1 to 4-n. That is, the arithmetic processing section 5 improves the accuracy of the arithmetic processing result by changing and optimizing the arithmetic processing according to the parameter information 72 and the integration times t. In the present embodiment, the arithmetic processing section 5 calculates the variances of the integration errors in the integration processing performed by the respective integration processing units 4-1 to 4-n based on the parameter information 72 and the integration times t, and performs arithmetic processing according to the calculated variances of the n integration errors. Further, the arithmetic processing section 5 calculates a weight coefficient for each of the output signals of the integration processing units 4-1 to 4-n based on the parameter information 72 and the integration time t, and performs arithmetic processing using the plurality of calculated weight coefficients. For example, the arithmetic processing section 5 calculates a plurality of weight coefficients based on the variances of n integration errors calculated based on the parameter information 72 and the integration times t.

### 1-2. Specific Configuration Example of Sensor Module

Hereinafter, a detailed operation of a sensor module 1A as a specific example of the sensor module 1 will be exemplified and the detailed operation thereof will be described.

The sensor module 1A is an inertial sensor module that detects accelerations in directions of three axes orthogonal to one another and angular velocities around the three axes. As illustrated in FIG. 4, for example, the sensor module 1A is mounted on an automobile 10 such that the three axes respectively extend along the X-axis, the Y-axis, and the Z-axis. The X-axis is an axis along the traveling direction of the automobile 10, the Y-axis is an axis in the rightward direction orthogonal to the traveling direction of the automobile 10, and the Z-axis is an axis along the downward direction perpendicular to the surface on which the automobile 10 travels.

The sensor module 1A calculates a roll angle φ, a pitch angle θ, and a yaw angle ψ of the automobile 10 based on the detected accelerations and angular velocities in the three axis directions. The roll angle φ is a rotation angle around the X-axis of the automobile 10 as a rotation axis, the pitch angle θ is a rotation angle around the Y-axis as a rotation axis, and the yaw angle ψ is a rotation angle around the Z-axis as a rotation axis. The roll angle φ and the pitch angle θ represent the attitude of the automobile 10, and the yaw angle ψ represents the relative azimuth of the automobile 10.

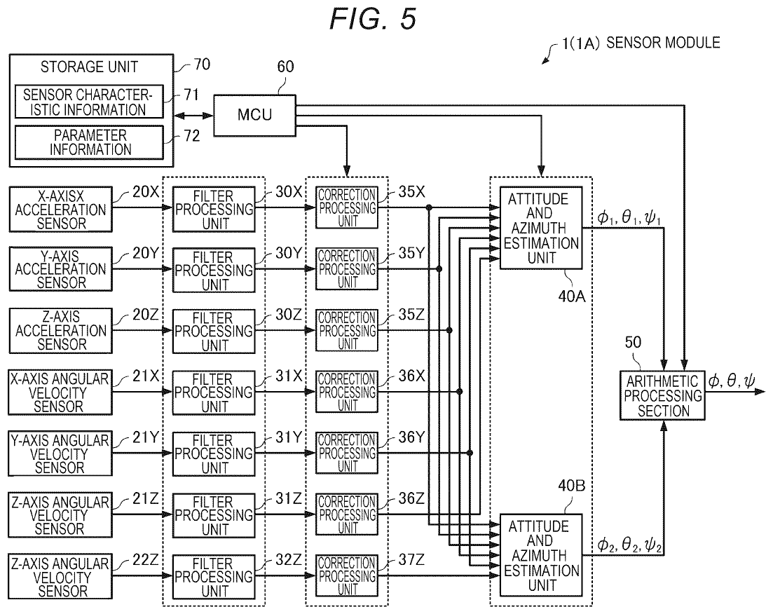

FIG. 5 shows a configuration example of the sensor module 1A. As shown in FIG. 5, the sensor module 1A includes an X-axis acceleration sensor 20X, a Y-axis acceleration sensor 20Y, a Z-axis acceleration sensor 20Z, an X-axis angular velocity sensor 21X, a Y-axis angular velocity sensor 21Y, a Z-axis angular velocity sensor 21Z, and a Z-axis angular velocity sensor 22Z, which are respectively inertial sensors. Further, the sensor module 1A includes filter processing units 30X, 30Y, 30Z, 31X, 31Y, 31Z, and 32Z and correction processing units 35X, 35Y, 35Z, 36X, 36Y, 36Z, and 37Z. Furthermore, the sensor module 1A includes attitude and azimuth estimation units 40A and 40B, an arithmetic processing section 50, a micro control unit 60, and a storage unit 70.

The X-axis acceleration sensor 20X detects an acceleration with the X-axis as a detection axis, and outputs a signal corresponding to the detected acceleration. The Y-axis acceleration sensor 20Y detects an acceleration with the Y-axis as a detection axis, and outputs a signal corresponding to the detected acceleration. The Z-axis acceleration sensor 20Z detects an acceleration with the Z-axis as a detection axis, and outputs a signal corresponding to the detected acceleration. For example, each of the X-axis acceleration sensor 20X, the Y-axis acceleration sensor 20Y, and the Z-axis acceleration sensor 20Z may be a quartz crystal acceleration sensor including a sensor element made of quartz crystal and detecting an acceleration with higher accuracy, or may be a capacitive MEMS acceleration sensor including a sensor element obtained by processing a silicon substrate by the MEMS technology. MEMS is an abbreviation for Micro Electro Mechanical Systems.

The X-axis angular velocity sensor 21X detects an angular velocity with the X axis as a detection axis, and outputs a signal corresponding to the detected angular velocity. The Y-axis angular velocity sensor 21Y detects an angular velocity with the Y-axis as a detection axis, and outputs a signal corresponding to the detected angular velocity. The Z-axis angular velocity sensor 21Z detects an angular velocity with the Z-axis as a detection axis, and outputs a signal corresponding to the detected angular velocity. The Z-axis angular velocity sensor 22Z detects an angular velocity with the Z-axis as a detection axis, and outputs a signal corresponding to the detected angular velocity. For example, each of the X-axis angular velocity sensor 21X, the Y-axis angular velocity sensor 21Y, the Z-axis angular velocity sensor 21Z, and the Z-axis angular velocity sensor 22Z may be a quartz crystal gyro sensor including a sensor element made of quartz crystal and detecting an angular velocity with higher accuracy, or may be a capacitive MEMS gyro sensor including a sensor element obtained by processing a silicon substrate by MEMS technology.

For example, each of the X-axis acceleration sensor 20X, the Y-axis acceleration sensor 20Y, and the Z-axis acceleration sensor 20Z outputs a digital signal having a value corresponding to the acceleration detected at a constant sampling period Δt, and each of the X-axis angular velocity sensor 21X, the Y-axis angular velocity sensor 21Y, the Z-axis angular velocity sensor 21Z, and the Z-axis angular velocity sensor 22Z outputs a digital signal having a value corresponding to the angular velocity detected at a constant sampling period Δt.

The storage unit 70 stores the sensor characteristic information 71 and the parameter information 72 described above. The sensor characteristic information 71 is information such as bias, sensitivity, misalignment, and temperature characteristics of each of the X-axis acceleration sensor 20X, the Y-axis acceleration sensor 20Y, the Z-axis acceleration sensor 20Z, the X-axis angular velocity sensor 21X, the Y-axis angular velocity sensor 21Y, the Z-axis angular velocity sensor 21Z, and the Z-axis angular velocity sensor 22Z. The parameter information 72 is information including values of parameters N₁, B₁, K₁, R₁ of the Allan variance, which are indexes representing the output stability of the Z-axis angular velocity sensor 21Z, and values of parameters N₂, B₂, K₂, R₂ of the Allan variance, which are indexes representing the output stability of the Z-axis angular velocity sensor 22Z. The parameters N₁, B₁, K₁, R₁ and the parameters N₂, B₂, K₂, R₂ respectively correspond to the parameters N, B, K, and R in Expression (1) described above.

The micro control unit 60 reads the sensor characteristic information 71 stored in the storage unit 70 and outputs the sensor characteristic information 71 to each of the correction processing units 35X, 35Y, 35Z, 36X, 36Y, 36Z, and 37Z. The micro control unit 60 reads the parameter information 72 stored in the storage unit 70 and outputs the parameter information 72 to the arithmetic processing section 50. Further, the micro control unit 60 outputs a signal for resetting integration processing described later to the attitude and azimuth estimation units 40A and 40B. Furthermore, the micro control unit 60 counts elapsed times since the reset of the integration processing by the attitude and azimuth estimation units 40A and 40B is released, and outputs the counted times as integration times t to the arithmetic processing section 50.

The filter processing unit 30X performs filter processing on the output signal of the X-axis acceleration sensor 20X to reduce a signal component in an unnecessary band. The filter processing unit 30Y performs filter processing on the output signal of the Y-axis acceleration sensor 20Y to reduce a signal component in an unnecessary band. The filter processing unit 30Z performs filter processing on the output signal of the Z-axis acceleration sensor 20Z to reduce a signal component in an unnecessary band.

The filter processing unit 31X performs filter processing on the output signal of the X-axis angular velocity sensor 21X to reduce a signal component in an unnecessary band. The filter processing unit 31Y performs filter processing on the output signal of the Y-axis angular velocity sensor 21Y to reduce a signal component in an unnecessary band. The filter processing unit 31Z performs filter processing on the output signal of the Z-axis angular velocity sensor 21Z to reduce a signal component in an unnecessary band.

The correction processing units 35X, 35Y, 35Z, 36X, 36Y, 36Z, and 37Z perform correction processing of bias, sensitivity, misalignment, temperature characteristics, and the like on the output signals of the filter processing units 30X, 30Y, 30Z, 31X, 31Y, 31Z, and 32Z based on the sensor characteristic information 71 output from the micro control unit 60. Then, the correction processing unit 35X outputs a signal having the corrected value of the X-axis acceleration, the correction processing unit 35Y outputs a signal having the corrected value of the Y-axis acceleration, and the correction processing unit 35Z outputs a signal having the corrected value of the Z-axis acceleration. The correction processing unit 36X outputs a signal having a value of the corrected X-axis angular velocity, the correction processing unit 36Y outputs a signal having a value of the corrected Y-axis angular velocity, and the correction processing units 36Z and 37Z output signals having a value of the corrected Z-axis angular velocity.

The attitude and azimuth estimation unit 40A estimates the relative attitude and azimuth of the sensor module 1A based on the output signals of the correction processing units 35X, 35Y, 35Z, 36X, 36Y, and 36Z. The attitude and azimuth estimation unit 40B estimates the relative attitude and azimuth of the sensor module 1A based on the output signals of the correction processing units 35X, 35Y, 35Z, 36X, 36Y, and 37Z. Since the sensor module 1A is fixed to the automobile 10, the relative attitude and azimuth of the sensor module 1A correspond to the relative attitude and azimuth of the automobile 10.

Specifically, the attitude and azimuth estimation units 40A and 40B calculate the respective angular velocities of the roll angle φ, the pitch angle θ, and the yaw angle ψ by Expression (6). In Expression (6), ωₓ is an X-axis angular velocity, ω_{y} is a Y-axis angular velocity, and ω_{z} is a Z-axis angular velocity.

$$[ \begin{matrix}\dot{φ} \\ \dot{θ} \\ \dot{ψ}\end{matrix} ] = [ \begin{matrix}1 & sin φ tan θ & cos φ tan θ \\ 0 & cos φ & - sin φ \\ 0 & sin φ / cos θ & cos φ / cos θ\end{matrix} ] [ \begin{matrix}{ω}_{x} \\ {ω}_{y} \\ {ω}_{z}\end{matrix} ] \qquad ( 6 )$$

Expression (6) is a differential equation with respect to time, and the relative values of the roll angle φ, the pitch angle θ, and the yaw angle ψ are obtained by multiplying both sides by the sampling period Δt. Each of the attitude and azimuth estimation units 40A and 40B calculates the roll angle φ, the pitch angle θ, and the yaw angle ψ by integrating the relative values of the roll angle φ, the pitch angle θ, and the yaw angle ψ for each sampling period Δt. The integration of the relative values of the roll angle φ, the pitch angle θ, and the yaw angle ψ corresponds to the integration processing. The attitude and azimuth estimation units 40A and 40B continue the integration processing from the release of the reset of the integration processing to the next reset by the micro control unit 60. The time during which the integration processing is continued corresponds to the integration time t.

Since the X-axis acceleration sensor 20X, the Y-axis acceleration sensor 20Y, and the Z-axis acceleration sensor 20Z can detect the gravitational accelerations, the attitude and azimuth estimation units 40A and 40B can calculate the absolute values of the roll angle φ and the pitch angle θ by Expression (7) based on the values of the three-axis accelerations of the sensor module 1A at rest. In Expression (7), aₓ is an X-axis acceleration, a_{y} is a Y-axis acceleration, and a_{z} is a Z-axis acceleration.

$$[ \begin{matrix}φ \\ θ\end{matrix} ] = [ \begin{matrix}{tan}^{- 1} ( {a}_{y} / {a}_{z} ) \\ {tan}^{- 1} ( {a}_{x} / \sqrt{{a}_{y}^{2} + {a}_{z}^{2}}\end{matrix} ] \qquad ( 7 )$$

In general, an angular velocity sensor and an acceleration sensor have advantages and disadvantages in attitude estimation. Therefore, the attitude and azimuth estimation units 40A and 40B perform calculation of integrating the roll angle φ and the pitch angle θ obtained based on Expression (6) and the roll angle φ and the pitch angle θ obtained based on Expression (7) using a Kalman filter or a complementary filter in order to complement the weak points of the sensors and estimate the attitude with higher accuracy. Then, the attitude and azimuth estimation unit 40A outputs the estimated roll angle φ₁, pitch angle θ₁, and yaw angle ψ₁, and the attitude and azimuth estimation unit 40B outputs the estimated roll angle φ₂, pitch angle θ₂, and yaw angle ψ₂.

The arithmetic processing section 50 performs arithmetic processing on the roll angle φ₁, the pitch angle θ₁, and the yaw angle ψ₁ as the output signals of the attitude and azimuth estimation unit 40A, and the roll angle φ₂, the pitch angle θ₂, and the yaw angle ψ₂ as the output signals of the attitude and azimuth estimation unit 40B. In the present embodiment, the arithmetic processing section 50 calculates the variances σ₁²(t) and σ₂²(t) of the integration errors in the integration processing performed by the respective attitude and azimuth estimation units 40A and 40B based on the parameters N₁, B₁, K₁, R₁, N₂, B₂, K₂, R₂ contained in the parameter information 72 and the integration times t, and performs arithmetic processing according to the calculated variances σ₁²(t) and σ₂²(t). Specifically, the arithmetic processing section 50 calculates a weight coefficient wᵢ for the output signal of the attitude and azimuth estimation unit 40A and a weight coefficient w₂ for the output signal of the attitude and azimuth estimation unit 40B based on the calculated variances σ₁²(t) and σ₂²(t), and performs arithmetic processing using the calculated weight coefficients w₁ and w₂.

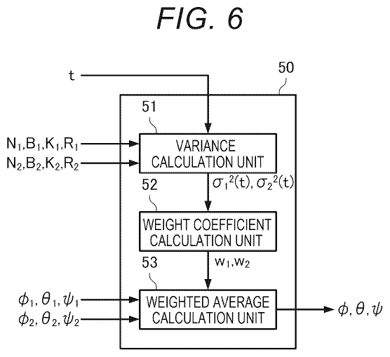

FIG. 6 shows a configuration example of the arithmetic processing section 50. As illustrated in FIG. 6, the arithmetic processing section 50 includes a variance calculation unit 51, a weight coefficient calculation unit 52, and a weighted average calculation unit 53.

The variance calculation unit 51 calculates the variance σ₁²(t) of the integration error in the integration processing performed by the attitude and azimuth estimation unit 40A by Expression (3) described above based on the parameters N₁, B₁, K₁, R₁ and the integration time t. Further, the variance calculation unit 51 calculates the variance σ₂²(t) of the integration error in the integration processing performed by the attitude and azimuth estimation unit 40B by Expression (3) described above based on the parameters N₂, B₂, K₂, R₂ and the integration time t. In Expression (3), N is N₁ or N₂, B is B₁ or B₂, K is K₁ or K₂, R is R₁ or R₂, and σ_{ang}²(t) is σ₁²(t) or σ₂²(t).

The weight coefficient calculation unit 52 calculates a weight coefficient w₁ for the roll angle φ₁, the pitch angle θ₁, and the yaw angle ψ₁ by Expression (8) based on the variance σ₁²(t) calculated by the variance calculation unit 51. Further, the weight coefficient calculation unit 52 calculates a weight coefficient w₂ for the roll angle φ₂, the pitch angle θ₂, and the yaw angle ψ₂ by Expression (8) based on the variance σ₂²(t) calculated by the variance calculation unit 51.

$${w}_{i} = \frac{1}{{σ}_{i}^{2} ( t )} \qquad ( 8 )$$

The weighted average calculation unit 53 calculates the roll angle φ by Expression (9) using the roll angles φ₁ and φ₂ and the weight coefficients w₁ and w₂ calculated by the weight coefficient calculation unit 52. The weighted average calculation unit 53 calculates the pitch angle θ by Expression (9) using the pitch angles θ₁ and θ₂ and the weight coefficients w₁ and w₂. The weighted average calculation unit 53 calculates the yaw angle ψ by Expression (9) using the yaw angles ψ₁ and ψ₂ and the weight coefficients w₁ and w₂. In Expression (9), x₁ is one of φᵢ, θᵢ, and ψᵢ, and y is one of φ, θ, and ψ.

$$y = \frac{{\sum }_{i = 1}^{n} {w}_{i} {x}_{i}}{{\sum }_{i = 1}^{n} {w}_{i}} \qquad ( 9 )$$

In FIG. 5, the detection axes of the Z-axis angular velocity sensor 21Z and the Z-axis angular velocity sensor 22Z are the Z-axis, and the physical quantities to be detected are the angular velocities. That is, the Z-axis angular velocity sensor 21Z corresponds to the sensor device 2-1 in FIG. 1, the Z-axis angular velocity sensor 22Z corresponds to the sensor device 2-2 in FIG. 1, and the integer n in FIG. 1 is 2. The filter processing unit 30Z and the correction processing unit 35Z correspond to the signal processing unit 3-1 in FIG. 1, and the filter processing unit 32Z and the correction processing unit 37Z correspond to the signal processing unit 3-2 in FIG. 1. The attitude and azimuth estimation unit 40A corresponds to the integration processing unit 4-1 in FIG. 1, and the attitude and azimuth estimation unit 40B corresponds to the integration processing unit 4-2 in FIG. 1. The arithmetic processing section 50 corresponds to the arithmetic processing section 5 in FIG. 1. The micro control unit 60 corresponds to the micro control unit 6 in FIG. 1. The storage unit 70 corresponds to the storage unit 7 in FIG. 1.

### 1-3. Functions and Effects

As described above, according to the sensor module 1 of the first embodiment, the appropriate arithmetic processing can be performed on a plurality of signals obtained by the integration processing based on the output signals of the plurality of sensor devices 2-1 to 2-n having the detection axes along the same direction and detecting the same type of physical quantity according to the parameters N, B, K, R of the Allan variance, which are indexes representing the output stability, and the integration times t. In particular, according to the sensor module 1 of the first embodiment, for each of the output signals of the plurality of integration processing units 4-1 to 4-n, the variance of the integration error of each of the plurality of integration processing units 4-1 to 4-n is calculated based on the parameters N, B, K, R of the Allan variance of each of the plurality of sensor devices 2-1 to 2-n and the integration time t, appropriate weighting is performed based on the plurality of calculated variances, and thus highly accurate arithmetic processing can be performed. Therefore, according to the sensor module 1 of the first embodiment, the possibility that the calculation accuracy decreases due to the change in the output stability of the plurality of sensor devices 2-1 to 2-n with time can be reduced.

In particular, the sensor module 1A as a specific example of the sensor module 1 according to the first embodiment includes two Z-axis angular velocity sensors 21Z and 22Z both having the Z-axis as the detection axes, and can perform appropriate arithmetic processing on the roll angle φ₁, the pitch angle θ₁, and the yaw angle ψ₁ obtained by the integration processing based on the output signal of the Z-axis angular velocity sensor 21Z and the roll angle φ₂, the pitch angle θ₂, and the yaw angle ψ₂ obtained by the integration processing based on the output signal of the Z-axis angular velocity sensor 22Z according to the parameters N₁, B₁, K₁, R₁ of the Allan variance of the Z-axis angular velocity sensor 21Z, the parameters N₂, B₂, K₂, R₂ of the Allan variance of the Z-axis angular velocity sensor 22Z, and the integration times t, and output the roll angle φ, the pitch angle θ, and the yaw angle ψ with higher accuracy.

### 2. Second Embodiment

Hereinafter, regarding a second embodiment, the same elements as those of the first embodiment have the same signs, overlapping description with the first embodiment will be omitted or simplified, and differences from the first embodiment will be mainly described.

Since the functional configuration and operation of the sensor module 1 of the second embodiment are the same as those in FIG. 1, illustration and description thereof will be omitted. Hereinafter, a detailed operation of a sensor module 1B as a specific example of the sensor module 1 of the second embodiment will be exemplified and the detailed operation thereof will be described.

Similarly to the sensor module 1A shown in FIG. 5, the sensor module 1B is an inertial sensor module that detects accelerations in directions of three axes orthogonal to one another and angular velocities around the three axes, and is mounted on the automobile 10 such that the three axes respectively extend along the X-axis, the Y-axis, and the Z-axis as shown in FIG. 4.

The sensor module 1B calculates, for example, the velocity and the position of the automobile 10 in an NED coordinate system, which is a coordinate system fixed to the earth, based on the detected accelerations and angular velocities in the three axis directions. NED is an abbreviation for North-East-Down.

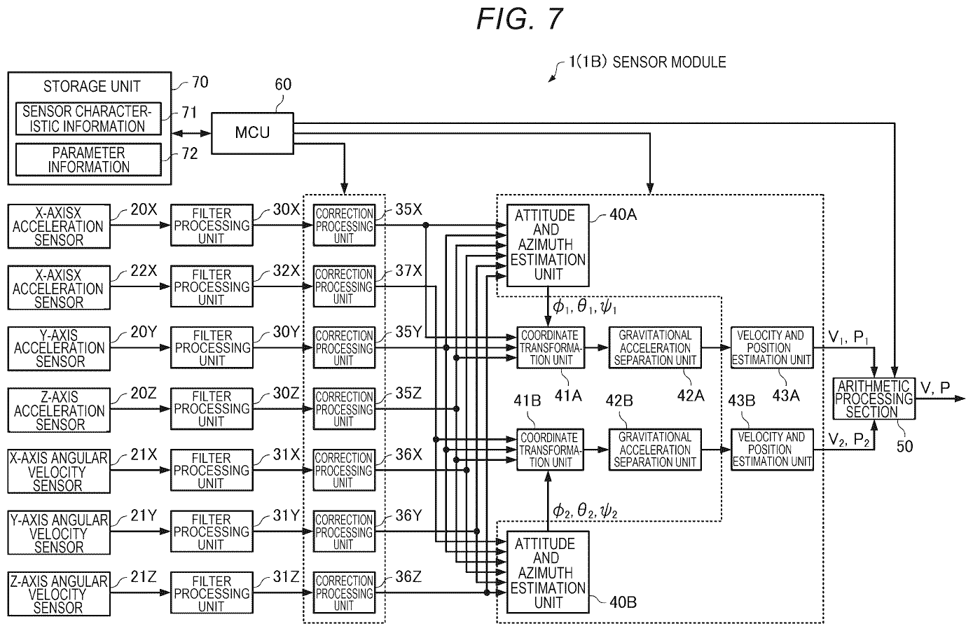

FIG. 7 shows a configuration example of the sensor module 1B. As shown in FIG. 7, the sensor module 1B includes the X-axis acceleration sensor 20X, an X-axis acceleration sensor 22X, the Y-axis acceleration sensor 20Y, the Z-axis acceleration sensor 20Z, the X-axis angular velocity sensor 21X, the Y-axis angular velocity sensor 21Y, and the Z-axis angular velocity sensor 21Z, which are respectively inertial sensors. The sensor module 1B includes filter processing units 30X, 32X, 30Y, 30Z, 31X, 31Y, and 31Z and correction processing units 35X, 37X, 35Y, 35Z, 36X, 36Y, and 36Z. The sensor module 1B includes attitude and azimuth estimation units 40A and 40B, coordinate transformation units 41A and 41B, gravitational acceleration separation units 42A and 42B, velocity and position estimation units 43A and 43B, an arithmetic processing section 50, the micro control unit 60, and a storage unit 70. That is, the sensor module 1B has a configuration in which the X-axis acceleration sensor 22X is provided instead of the Z-axis angular velocity sensor 22Z, and the coordinate transformation units 41A and 41B, the gravitational acceleration separation units 42A and 42B, and the velocity and position estimation units 43A and 43B are further added to the sensor module 1A illustrated in FIG. 5.

Since the processing of the X-axis acceleration sensor 20X, the Y-axis acceleration sensor 20Y, the Z-axis acceleration sensor 20Z, the X-axis angular velocity sensor 21X, the Y-axis angular velocity sensor 21Y, and the Z-axis angular velocity sensor 21Z is the same as that in the first embodiment, the description thereof will be omitted.

The X-axis acceleration sensor 22X detects an acceleration with the X-axis as a detection axis, and outputs a signal corresponding to the detected acceleration. For example, the X-axis acceleration sensor 22X may be a quartz crystal acceleration sensor including a sensor element made of quartz crystal and detecting the acceleration with higher accuracy, or may be a capacitive MEMS acceleration sensor including a sensor element obtained by processing a silicon substrate by MEMS technology. For example, the X-axis acceleration sensor 22X outputs a digital signal having a value corresponding to the acceleration detected at a constant sampling period Δt.

The storage unit 70 stores sensor characteristic information 71 and parameter information 72. The sensor characteristic information 71 is information such as bias, sensitivity, misalignment, and temperature characteristics of each of the X-axis acceleration sensor 20X, the X-axis acceleration sensor 22X, the Y-axis acceleration sensor 20Y, the Z-axis acceleration sensor 20Z, the X-axis angular velocity sensor 21X, the Y-axis angular velocity sensor 21Y, and the Z-axis angular velocity sensor 21Z. The parameter information 72 is information including values of parameters N₁, B₁, K₁, R₁ of the Allan variance, which are indexes representing the output stability of the X-axis acceleration sensor 20X and values of parameters N₂, B₂, K₂, R₂ of the Allan variance, which are indexes representing the output stability of the X-axis acceleration sensor 22X. The parameters N₁, B₁, K₁, R₁ and the parameters N₂, B₂, K₂, R₂ respectively correspond to the parameters N, B, K, and R in Expression (1) described above.

The micro control unit 60 reads the sensor characteristic information 71 stored in the storage unit 70 and outputs the sensor characteristic information 71 to each of the correction processing units 35X, 37X, 35Y, 35Z, 36X, 36Y, and 36Z. The micro control unit 60 reads the parameter information 72 stored in the storage unit 70 and outputs the parameter information 72 to the arithmetic processing section 50. Further, the micro control unit 60 outputs a signal for resetting integration processing to be described later to the attitude and azimuth estimation units 40A and 40B and the velocity and position estimation units 43A and 43B. Furthermore, the micro control unit 60 counts elapsed times since the reset of the integration processing by the attitude and azimuth estimation units 40A and 40B and the velocity and position estimation units 43A and 43B is released, and outputs the counted times as integration times t to the arithmetic processing section 50.

Since the processing of the filter processing units 30X, 30Y, 30Z, 31X, 31Y, and 31Z is the same as that of the first embodiment, the description thereof will be omitted. The filter processing unit 32X performs filter processing on the output signal of the X-axis acceleration sensor 22X to reduce a signal component in an unnecessary band.

Since the processing of the correction processing units 35X, 35Y, 35Z, 36X, 36Y, and 36Z is the same as that of the first embodiment, the description thereof will be omitted.

The correction processing unit 37X performs correction processing of bias, sensitivity, misalignment, temperature characteristics, and the like on the output signal of the filter processing unit 32X based on the sensor characteristic information 71 output from the micro control unit 60. Then, the correction processing unit 37X outputs a signal having the corrected value of the X-axis acceleration.

The attitude and azimuth estimation unit 40A estimates the relative attitude and azimuth of the sensor module 1B based on the output signals of the correction processing units 35X, 35Y, 35Z, 36X, 36Y, and 36Z. Since the processing of the attitude and azimuth estimation unit 40A is the same as that of the first embodiment, the description thereof will be omitted. The attitude and azimuth estimation unit 40B estimates the relative attitude and azimuth of the sensor module 1B based on the output signals of the correction processing units 37X, 35Y, 35Z, 36X, 36Y, and 36Z. The attitude and azimuth estimation unit 40B is different from the first embodiment in that the output signals of the correction processing units 37X and 36Z are input instead of the output signals of the correction processing units 35X and 37Z, but the processing thereof is the same as that of the first embodiment, and thus the description thereof will be omitted. Since the sensor module 1B is fixed to the automobile 10, the relative attitude and azimuth of the sensor module 1B correspond to the relative attitude and azimuth of the automobile 10.

The coordinate transformation unit 41A transforms the values of the three-axis accelerations of the XYZ coordinate system, which are the output signals of the correction processing units 35X, 35Y, and 35Z, into the three-axis accelerations of the NED coordinate system based on the roll angle φ₁, the pitch angle θ₁, and the yaw angle ψ₁, which are the output signals of the attitude and azimuth estimation unit 40A. Further, the coordinate transformation unit 41B transforms the values of the three-axis accelerations of the XYZ coordinate system, which are the output signals of the correction processing units 37X, 35Y, and 35Z, into the three-axis accelerations of the NED coordinate system based on the roll angle φ₂, the pitch angle θ₂, and the yaw angle ψ₂, which are the output signals of the attitude and azimuth estimation unit 40B.

Specifically, each of the coordinate transformation units 41A and 41B transforms a three-dimensional acceleration vector a representing the three-axis accelerations of the XYZ coordinate system into a three-dimensional acceleration vector A representing the three-axis accelerations of the NED coordinate system by Expression (10).

$$A = {C}_{g / l} a \qquad ( 10 )$$

In Expression (10), C_{g/l} is a rotation matrix representing coordinate transformation of a vector in a three-dimensional space called a direction cosine matrix, and is expressed by Expression (11). In Expression (11), the roll angle φ, the pitch angle θ, and the yaw angle ψ are the roll angle φ₁, the pitch angle θ₁, and the yaw angle ψ₁, or the roll angle φ₂, the pitch angle θ₂, and the yaw angle ψ₂. As shown in Expression (11), coordinate transformation of the accelerations can be performed using the roll angle φ, the pitch angle θ, and the yaw angle ψ.

$${C}_{g / l} = [ \begin{matrix}cos θ cos ψ & sin φ sin θ cos ψ - cos φ sin ψ & cos φ sin θcos ψ + sin φ sin ψ \\ cos θ sin ψ & sin φ sin θ sin ψ + cos φ cos ψ & cos φ sin θcos ψ - sin φ cos ψ \\ - sin θ & sin Φ cos θ & cos Φcos θ\end{matrix} ] \qquad ( 11 )$$

The three-axis accelerations as the output signals of the coordinate transformation units 41A and 41B include both the gravitational accelerations and the movement accelerations. The gravitational acceleration separation units 42A and 42B separate the gravitational accelerations contained in the output signals of the coordinate transformation units 41A and 41B, respectively. Specifically, the gravitational acceleration separation units 42A and 42B calculate three-dimensional acceleration vectors Aₘ obtained by separating three-dimensional gravitational acceleration vectors G from the three-dimensional acceleration vectors A representing the three-axis accelerations, which are the output signals of the coordinate transformation units 41A and 41B, by Expressions (12) and (13), respectively. In Expression (13), g is the gravitational acceleration.

$${A}_{m} = A - G \qquad ( 12 )$$

$$G = [ \begin{matrix}0 \\ 0 \\ - g\end{matrix} ] \qquad ( 13 )$$

The velocity and position estimation units 43A and 43B estimate the velocities and the positions of the sensor module 1B based on the output signals of the gravitational acceleration separation units 42A and 42B, respectively. Specifically, the velocity and position estimation units 43A and 43B calculate three-dimensional velocity vectors V in the NED coordinate system by integrating the three-dimensional acceleration vectors Aₘ representing the three-axis accelerations, which are the output signals of the gravitational acceleration separation units 42A and 42B, by Expression (14), respectively. Further, each of the velocity and position estimation units 43A and 43B further integrates the three-dimensional velocity vector V calculated by Expression (14) to calculate a three-dimensional position vector P in the NED coordinate system by Expression (15). In Expression (14), A_{m,k} is the three-dimensional acceleration vector Aₘ at time k, and Vₖ₋₁ is the three-dimensional velocity vector V at time k−1. In Expressions (14) and (15), Vₖ is the three-dimensional velocity vector V at the time k, and Δt is the sampling period. In Expression (15), Pₖ₋₁ is the three-dimensional position vector P at time k−1, and Pₖ is the three-dimensional position vector P at time k.

$${V}_{k} = {A}_{m , k} Δ t + {V}_{k - 1} \qquad ( 14 )$$

$${P}_{k} = {V}_{k} Δ t + {P}_{k - 1} \qquad ( 15 )$$

The arithmetic processing section 50 performs arithmetic processing on a three-dimensional velocity vector V₁ as the output signal of the velocity and position estimation unit 43A and a three-dimensional velocity vector V₂ as the output signal of the velocity and position estimation unit 43B based on the parameter information 72. The arithmetic processing section 50 performs arithmetic processing on a three-dimensional position vector P₁ as the output signal of the speed and position estimation unit 43A and a three-dimensional position vector P₂ as the output signal of the speed and position estimation unit 43B based on the parameter information 72. The parameter information 72 is information including values of parameters N₁, B₁, K₁, R₁ of the Allan variance, which are indexes representing the output stability of the X-axis acceleration sensor 20X and values of parameters N₂, B₂, K₂, R₂ of the Allan variance, which are indexes representing the output stability of the X-axis acceleration sensor 22X.

In the present embodiment, the arithmetic processing section 50 calculates a velocity variance σᵥₑₗ₁²(t), which is the variance of the integration error in the integration processing of the acceleration performed by the velocity and position estimation unit 43A, based on the parameters N₁, B₁, K₁, R₁ and the integration time t by Expression (4). Further, the arithmetic processing section 50 calculates a velocity variance σᵥₑₗ₂²(t), which is the variance of the integration error in the integration processing of the acceleration performed by the velocity and position estimation unit 43B, based on the parameter N₂, B₂, K₂, R₂ and the integration time t by Expression (4). Then, the arithmetic processing section 50 performs arithmetic processing according to the calculated variances σᵥₑₗ₁²(t) and σᵥₑₗ₂²(t). Specifically, the arithmetic processing section 50 calculates a weight coefficient w₁ for the output signal of the velocity and position estimation unit 43A and a weight coefficient w₂ for the output signal of the velocity and position estimation unit 43B based on the calculated variances σᵥₑₗ₁²(t) and σᵥₑₗ₂²(t) by Expression (8). Then, the arithmetic processing section 50 calculates a three-dimensional velocity vector V by Expression (9) described above using the three-dimensional velocity vectors V₁ and V₂ and the weight coefficients w₁ and w₂. In Expression (9), x₁ is V₁, and y is V.

The arithmetic processing section 50 calculates a variance σₚₒₛ₁²(t) of the position, which is the variance of the integration error in the double integration of the acceleration performed by the velocity and position estimation unit 43A, based on the parameters N₁, B₁, K₁, R₁ and the integration time t by Expression (5) described above. The arithmetic processing section 50 calculates a variance σₚₒₛ₂²(t) of the position, which is the variance of the integration error in the double integration of the acceleration performed by the velocity and position estimation unit 43B, based on the parameters N₂, B₂, K₂, R₂ and the integration time t by Expression (5) described above. Then, the arithmetic processing section 50 performs arithmetic processing according to the calculated variances σₚₒₛ₁²(t) and σₚₒₛ₂²(t). Specifically, the arithmetic processing section 50 calculates a weight coefficient w₁ for the output signal of the velocity and position estimation unit 43A and a weight coefficient w₂ for the output signal of the velocity and position estimation unit 43B based on the calculated variances σₚₒₛ₁²(t) and σₚₒₛ₂²(t) by Expression (8) described above. Then, the arithmetic processing section 50 calculates a three-dimensional position vector P by Expression (9) described above using the three-dimensional position vectors P₁ and P₂ and the weight coefficients wᵢ and w₂. In Expression (9), xᵢ is P₁, and y is P.

In FIG. 7, the detection axes of the X-axis acceleration sensor 20X and the X-axis acceleration sensor 22X are the X-axis, and the physical quantities to be detected are the accelerations. That is, the X-axis acceleration sensor 20X corresponds to the sensor device 2-1 in FIG. 1, the X-axis acceleration sensor 22X corresponds to the sensor device 2-2 in FIG. 1, and the integer n in FIG. 1 is 2. The filter processing unit 30X and the correction processing unit 35X correspond to the signal processing unit 3-1 in FIG. 1, and the filter processing unit 32X and the correction processing unit 37X correspond to the signal processing unit 3-2 in FIG. 1. The velocity and position estimation unit 43A corresponds to the integration processing unit 4-1 in FIG. 1, and the velocity and position estimation unit 43B corresponds to the integration processing unit 4-2 in FIG. 1. The arithmetic processing section 50 corresponds to the arithmetic processing section 5 in FIG. 1. The micro control unit 60 corresponds to the micro control unit 6 in FIG. 1. The storage unit 70 corresponds to the storage unit 7 in FIG. 1.

According to the sensor module 1 of the second embodiment described above, the same effects as those of the sensor module 1 of the first embodiment can be obtained. In particular, the sensor module 1B as the specific example of the sensor module 1 of the second embodiment includes the two X-axis acceleration sensors 20X and 22X both having the X-axis as the detection axes, and can perform appropriate arithmetic processing on the three-dimensional velocity vector V₁ and the three-dimensional position vector P₁ obtained by the integration processing based on the output signal of the X-axis acceleration sensor 20X and the three-dimensional velocity vector V₂ and the three-dimensional position vector P₂ obtained by the integration processing based on the output signal of the X-axis acceleration sensor 22X according to the parameters N₁, B₁, K₁, R₁ of the Allan variance of the X-axis acceleration sensor 20X, the parameters N₂, B₂, K₂, R₂ of the Allan variance of the X-axis acceleration sensor 22X, and the integration times t, and output the three-dimensional velocity vector V and the three-dimensional position vector P with higher accuracy.

### 3. Third Embodiment

Hereinafter, regarding a third embodiment, the same elements as those of the first embodiment or the second embodiment have the same signs, the overlapping description with the first embodiment or the second embodiment will be omitted or simplified, and differences from the first embodiment or the second embodiment will be mainly described.

Since the functional configuration and operation of the sensor module 1 of the third embodiment are the same as those in FIG. 1, illustration and description thereof will be omitted. However, in the sensor module 1 of the third embodiment, the processing of the arithmetic processing section 5 is different from that of the first embodiment and the second embodiment. The arithmetic processing section 5 in the third embodiment selects at least one signal from the output signals of the integration processing units 4-1 to 4-n based on the parameter information 72 and the integration times t, and performs arithmetic processing based on the selected signal. For example, the arithmetic processing section 5 may perform arithmetic processing of selecting one signal from the output signals of the integration processing units 4-1 to 4-n and outputting the selected signal as it is. The arithmetic processing section 5 may select a plurality of signals from the output signals of the integration processing units 4-1 to 4-n and perform arithmetic processing on the selected plurality of signals.

Specifically, the arithmetic processing section 5 may calculate variances σ₁²(t) to σₙ²(t) of the integration errors in the integration processing of the respective integration processing units 4-1 to 4-n based on the parameter information 72 and the integration times t, and select the output signal of the integration processing unit 4-j when σⱼ²(t) is the smallest among the variances σ₁²(t) to σₙ²(t). However, since the calculation variations of the Allan variance become larger as the average time T increases, the variations of the parameter calculated in a portion where the average time T is larger are larger, and the accuracy of the parameter of each of the sensor devices 2-1 to 2-n may be different. Therefore, the arithmetic processing section 5 may select at least one signal from the output signals of the integration processing units 4-1 to 4-n based on the parameter information 72, the integration times t, and the coefficients k₁ to kₙ according to the accuracy of the respective parameters of the sensor devices 2-1 to 2-n. For each integer i from 1 to n, the coefficient k₁ may be set to be larger as the accuracy of the parameters N, B, K, and R of the sensor device 2-i is lower. For example, the arithmetic processing section 5 may calculate a product kᵢσᵢ²(t) of the variance σᵢ²(t) and the coefficient kᵢ for each integer i from 1 to n, and select the output signal of the integration processing unit 4-j when kⱼσⱼ²(t) is the smallest among k₁σ₁²(t) to kₙσₙ²(t). The coefficients kᵢ to kₙ are fixed values and may be contained in the parameter information 72. Alternatively, the value of the coefficient kᵢ may be changed according to the integration time t in the integration processing of the integration processing unit 4-i, and the value of the coefficient kᵢ may be set to be larger as the integration time t is longer.

A specific example of the sensor module 1 of the third embodiment is similar to the sensor module 1B illustrated in FIG. 5, but the configuration of the arithmetic processing section 50 is different from that in FIG. 6.

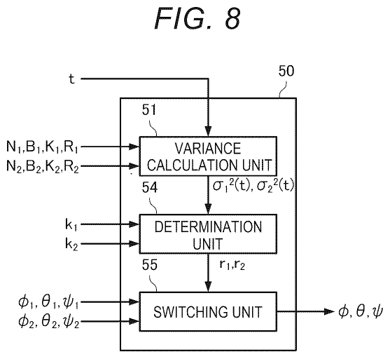

FIG. 8 shows a configuration example of the arithmetic processing section 50 in the third embodiment. As illustrated in FIG. 8, the arithmetic processing section 50 includes the variance calculation unit 51, a determination unit 54, and a switching unit 55. Since the processing of the distribution calculation unit 51 is the same as the processing of the distribution calculation unit 51 in FIG. 6, the description thereof will be omitted.

The determination unit 54 outputs variables r₁ and r₂ based on the variances σ₁²(t) and σ₂²(t) calculated by the variance calculation unit 51 and the coefficients kᵢ and k₂. Specifically, the determination unit 54 calculates a product k₁σ₁²(t) of the variance σ₁²(t) calculated by the variance calculation unit 51 and the coefficient kᵢ. The determination unit 54 calculates a product k₂σ₂²(t) of the variance σ₂²(t) calculated by the variance calculation unit 51 and the coefficient k₂. Then, the determination unit 54 outputs r₁=0 and r₂=1 for k₁σ₁²(t)≥k₂σ₂² (t), and outputs r₁=1 and r₂=0 for k₁σ₁²(t)<k₂σ₂² (t).

The switching unit 55 calculates a roll angle φ by Expression (16) using the roll angles φ₁ and φ₂ and the variables r₁ and r₂ which are the output signals of the determination unit 54. Further, the switching unit 55 calculates a pitch angle θ by Expression (16) using the pitch angles θ₁ and θ₂ and the variables r₁ and r₂. Furthermore, the switching unit 55 calculates a yaw angle ψ by Expression (16) using the yaw angles ψ₁ and ψ₂ and the variables rᵢ and r₂. In Expression (16), xᵢ is one of φ₁, θ₁, and ψ₁, and y is one of φ, θ, and ψ.

$$y = {r}_{1} {x}_{1} + {r}_{2} {x}_{2} \qquad ( 16 )$$

A specific example of the sensor module 1 of the third embodiment may be the same as that of the sensor module 1B shown in FIG. 7. In this case, in Expression (16), xᵢ is Vᵢ or Pᵢ, and y is V or P.

According to the sensor module 1 of the third embodiment described above, for each of the output signals of the plurality of integration processing units 4-1 to 4-n, the variance of the integration error of each of the plurality of integration processing units 4-1 to 4-n is calculated based on the parameters N, B, K, R of the Allan variance of each of the plurality of sensor devices 2-1 to 2-n and the integration time t, and an appropriate signal is selected from the output signals of the plurality of integration processing units 4-1 to 4-n based on the plurality of calculated variances based on the parameters N, B, K, R of the Allan variance of each of the plurality of sensor devices 2-1 to 2-n and the integration time t, and thus the highly accurate arithmetic processing can be performed. Further, according to the sensor module 1 of the third embodiment, the more highly accurate arithmetic processing can be performed by selecting an appropriate signal from the output signals of the plurality of integration processing units 4-1 to 4-n by the coefficients k₁ to kₙ in consideration of the accuracy of the parameters N, B, K, R of the Allan variance of each of the plurality of sensor devices 2-1 to 2-n. Therefore, according to the sensor module 1 of the third embodiment, the possibility that the calculation accuracy decreases due to the change in the output stability of the plurality of sensor devices 2-1 to 2-n with time can be reduced.

In addition, according to the sensor module 1 of the third embodiment, the same effects as those of the sensor module 1 of the first embodiment or the second embodiment can be obtained.

### 4. Application Example

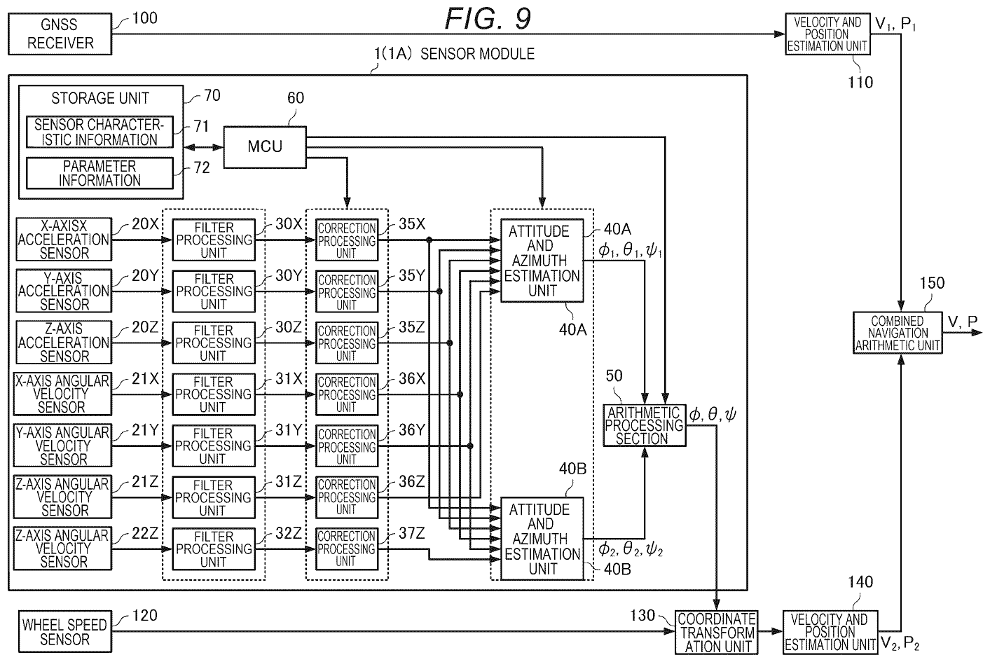

The sensor module 1 of each of the embodiments described above can be used in, for example, a combined navigation system using a GNSS and an INS (Inertial Navigation System). FIG. 9 shows an example of the combined navigation system incorporating the sensor module 1A shown in FIG. 5. The combined navigation system illustrated in FIG. 9 includes the sensor module 1, a GNSS receiver 100, a velocity and position estimation unit 110, a wheel speed sensor 120, a coordinate transformation unit 130, a velocity and position estimation unit 140, and a combined navigation arithmetic unit 150, and is mounted on the automobile 10.

The sensor module 1A outputs the roll angle φ, the pitch angle θ, and the yaw angle ψ calculated by the arithmetic processing section 50 to the outside.

The GNSS receiver 100 receives satellite signals transmitted from a plurality of satellites constituting a part of a GNSS (Global Navigation Satellite System) via an antenna (not illustrated), performs positioning based on the received satellite signals, and outputs position information. Examples of the GNSS include GPS (Global Positioning System), QZSS (Quasi Zenith Satellite System), EGNOS (European Geostationary Navigation Overlay Service), GLONASS (Global Navigation Satellite System), GALILEO, and BeiDou.

The velocity and position estimation unit 110 estimates the velocity and position of the automobile 10 based on the position information output from the GNSS receiver 100, and outputs a three-dimensional speed vector V₁ and a three-dimensional position vector P₁ in the NED coordinate system.

The wheel speed sensor 120 detects a rotation speed of a wheel of the automobile 10 and outputs a wheel speed signal.

The coordinate transformation unit 130 transforms the wheel speed signal output from the wheel speed sensor 120 into a three-axis velocity signal of the NED coordinate system based on the roll angle φ, the pitch angle θ, and the yaw angle ψ output from the sensor module 1.

The velocity and position estimation unit 140 estimates the velocity and position of the automobile 10 based on the three-axis velocity signal output from the coordinate transformation unit 130, and outputs a three-dimensional velocity vector V₂ and a three-dimensional position vector P₂ in the NED coordinate system.

The combined navigation arithmetic unit 150 performs arithmetic processing of combined navigation using the three-dimensional velocity vector V₁ and the three-dimensional position vector P₁ as the output signals of the velocity and position estimation unit 110 and the three-dimensional velocity vector V₂ and the three-dimensional position vector P₂ as the output signals of the velocity and position estimation unit 140, and calculates a three-dimensional velocity vector V and a three-dimensional position vector P indicating the velocity and position of the automobile 10.

The combined navigation in the system in FIG. 9 is loose coupling of integrating the estimation result of the velocity and position based on the GNSS and the estimation result of the velocity and position based on the INS, but other combined navigation includes tight coupling of integrating raw data based on the GNSS and the estimation result of the INS, deep coupling of feeding back the estimation result of the INS to tracking of the GNSS, and the like.

### 5. Modification Examples

The present disclosure is not limited to the present embodiments, but various modifications can be made within the scope of the gist of the present disclosure.

For example, the sensor module 1A shown in FIG. 5 and the sensor module 1B shown in FIG. 7 may be combined. Specifically, in the sensor module 1B, the coordinate transformation units 41A and 41B may perform coordinate transformation using the roll angle φ, the pitch angle θ, and the yaw angle ψ as the output signals of the arithmetic processing section 50 of the sensor module 1A. In particular, the configuration described above is effective in navigation of a vehicle mainly moving in the X-axis directions and around the Z-axis, such as the automobile 10.

Further, for example, in the third embodiment, the arithmetic processing section 5 may select two or more signals from the output signals of the integration processing units 4-1 to 4-n, multiply the selected two or more signals by the weight coefficient calculated by Expression (8), and perform the arithmetic processing of Expression (9). That is, the arithmetic processing section 50 illustrated in FIG. 6 and the arithmetic processing section 50 illustrated in FIG. 8 may be combined.

For example, in each of the embodiments described above, the example in which the sensor module 1 is mounted on the automobile 10 has been described, however, the sensor module 1 may be mounted on a vehicle other than the automobile. Examples of the vehicles other than the automobile include agricultural machines such as tractors, construction machines such as excavators, automated guided vehicles, robot lawn mowers, robot cleaners, aircrafts such as jet planes and helicopters, vessels, rockets, artificial satellites, railway vehicles, aerial drones, and underwater drones.

The embodiments and modification examples described above are merely examples, and the present disclosure is not limited thereto. For example, the respective embodiments and the respective modification examples may be combined as appropriate.

The present disclosure includes substantially the same configurations as the configurations described in the embodiments, for example, configurations having the same functions, methods, and results or configurations having the same purposes and effects. The present disclosure includes a configuration in which a non-essential portion of the configuration described in the embodiments is replaced. Further, the present disclosure includes a configuration that exerts the same function and effect or a configuration that can achieve the same purpose as the configurations described in the embodiments. Furthermore, the present disclosure includes a configuration with the addition of a known technique to the configuration described in the embodiments.

The following configurations are derived from the embodiments and the modifications described above.

A sensor module includes a plurality of sensor devices that have detection axes along the same direction and detect the same type of physical quantity, a storage unit that stores parameter information including parameters as indexes representing output stability of the respective plurality of sensor devices, a plurality of integration processing units that perform integration processing based on output signals of the respective plurality of sensor devices, and an arithmetic processing section that performs arithmetic processing according to the parameter information and integration times of the integration processing on the output signals of the plurality of integration processing units.

According to the sensor module, the appropriate arithmetic processing can be performed on a plurality of signals obtained by the integration processing based on the output signals of the plurality of sensor devices having the detection axes along the same direction and detecting the same type of physical quantity according to the parameters as indexes representing the output stability and the integration times. Therefore, according to the sensor module, the possibility that the calculation accuracy decreases due to the change in the output stability of the plurality of sensor devices with time can be reduced.

In the sensor module, the arithmetic processing section may calculate a weight coefficient for each of the output signals of the plurality of integration processing units based on the parameter information and the integration time, and perform the arithmetic processing using the plurality of calculated weight coefficients.

According to the sensor module, the appropriate weighting is performed on each of the output signals of the plurality of integration processing units based on the parameter as the index representing the output stability of each of the plurality of sensor devices and the integration times, and thus highly accurate arithmetic processing can be performed.

In the sensor module, the arithmetic processing section may select at least one signal from the output signals of the plurality of integration processing units based on the parameter information and the integration times, and perform the arithmetic processing based on the selected signal.

According to the sensor module, the highly accurate arithmetic processing can be performed by selecting an appropriate signal from the output signals of the plurality of integration processing units based on the parameters as indexes representing the output stability of the respective plurality of sensor devices and the integration times.

In the sensor module, the arithmetic processing section may at least one signal from the output signals of the plurality of integration processing units based on the parameter information, the integration times, and coefficients according to accuracy of the parameters of the respective plurality of sensor devices contained in accuracy of the parameter information.

According to the sensor module, the more highly accurate arithmetic processing can be performed by selecting an appropriate signal from the output signals of the plurality of integration processing units in consideration of the accuracy of the parameters as indexes representing the output stability of the respective plurality of sensor devices.

In the sensor module, the arithmetic processing section may calculate a variance of an integration error in the integration processing performed by each of the plurality of integration processing units based on the parameter information and the integration times, and perform the arithmetic processing according to the calculated variances of the plurality of integration errors.

According to the sensor module, the highly accurate arithmetic processing can be performed according to the variances of the integration errors of the respective plurality of integration processing units.

In the sensor module, each of the plurality of sensor devices may be an angular velocity sensor, and each of the output signals of the plurality of integration processing units may be a signal corresponding to an attitude or an azimuth.

According to the sensor module, the appropriate arithmetic processing can be performed on a plurality of signals corresponding to the attitude or the azimuth obtained by the integration processing based on the output signals of the plurality of angular velocity sensors having the detection axes along the same direction according to the parameters as the indexes representing the output stability and the integration times. Therefore, according to the sensor module, the possibility that the calculation accuracy related to the attitude or the azimuth decreases due to the change in the output stability of the plurality of angular velocity sensors with time can be reduced.

In the sensor module, each of the plurality of sensor devices may be an acceleration sensor, and each of the output signals of the plurality of integration processing units may be a signal corresponding to a velocity or a position.

According to the sensor module, the appropriate arithmetic processing can be performed on a plurality of signals corresponding to the velocity or the position obtained by integration processing based on the output signals of the plurality of acceleration sensors having detection axes along the same direction according to the parameters as indexes representing output stability and the integration times. Therefore, according to the sensor module, the possibility that the calculation accuracy related to the velocity or the position decreases due to the change in the output stability of the plurality of acceleration sensors with time can be reduced.

What is claimed is:

1. A sensor module comprising:
a plurality of sensor devices that have detection axes along a same direction and detect a same type of physical quantity;
a storage unit that stores parameter information including parameters as indexes representing output stability of the respective plurality of sensor devices;
a plurality of integration processing units that perform integration processing based on output signals of the respective plurality of sensor devices; and
an arithmetic processing section that performs arithmetic processing according to the parameter information and integration times of the integration processing on the output signals of the plurality of integration processing units.

2. The sensor module according to claim 1, wherein
the arithmetic processing section calculates a weight coefficient for each of the output signals of the plurality of integration processing units based on the parameter information and the integration times, and performs the arithmetic processing using the plurality of calculated weight coefficients.

3. The sensor module according to claim 1, wherein
the arithmetic processing section selects at least one signal from the output signals of the plurality of integration processing units based on the parameter information and the integration times, and performs the arithmetic processing based on the selected signal.

4. The sensor module according to claim 3, wherein
the arithmetic processing section selects at least one signal from the output signals of the plurality of integration processing units based on the parameter information, the integration times, and coefficients according to accuracy of the parameters of the respective plurality of sensor devices contained in accuracy of the parameter information.

5. The sensor module according to claim 1, wherein
the arithmetic processing section calculates a variance of an integration error in the integration processing performed by each of the plurality of integration processing units based on the parameter information and the integration time, and performs the arithmetic processing according to the calculated variances of the plurality of integration errors.

6. The sensor module according to claim 1, wherein
each of the plurality of sensor devices is an angular velocity sensor, and
each of the output signals of the plurality of integration processing units is a signal corresponding to an attitude or an azimuth.

7. The sensor module according to claim 1, wherein
each of the plurality of sensor devices is an acceleration sensor, and
each of the output signals of the plurality of integration processing units is a signal corresponding to a velocity or a position.
